(19) United States
(12) Patent Application Publication
(10) Pub. No.: US 2005/0133431 A1
(43) Pub. Date: Jun. 23, 2005

(54) In-home water treatment system

(76) Inventor: Christopher R. Schulz, Centennial, CO (US)

Correspondence Address: ALFRED J MANGELS, 4729 CORNELL ROAD, CINCINNATI, OH, 452412433, US

(21) Appl. No.: 10/743,032

(22) Filed: Dec. 23, 2003

(51) Int. Cl. C02F 9/00; C02F 9/12; C02F 1/32

(52) U.S. Cl. 210/256; 210/748; 210/209

(57) ABSTRACT

An in-home water treatment system that provides three stages of treatment for incoming water. The first treatment stage is a particulate removal stage, utilizing a spun fiber filter pad. The second treatment stage is a chemical compound removal stage, utilizing a carbon block filter. The third treatment stage is a disinfection stage utilizing an ultraviolet lamp. The three treatment stages are contained within a tubular enclosure to provide stage-by-stage treatment of the incoming water to improve its quality.

### BACKGROUND OF THE INVENTION

1. Field of the Invention

The present invention relates to a water filtration and ultraviolet light disinfection apparatus and method that are suitable for use as a point-of-entry or point-of-use water treatment system in the home. More particularly, the present invention relates to an improved home water treatment system and method that provides several water treatment stages for improved water quality, including particulate filtration, inorganic and organic contaminant removal, and microorganism inactivation.

2. Description of the Related Art

Point-of-entry and point-of-use water treatment arrangements for use in homes have been available for some time. Point-of use devices provide localized water treatment at a particular point within the home, such as filters that are attached to faucets. Point-of-entry devices are arranged near the home water-service entry point to provide whole-house water treatment. The point-of-entry devices in common use range from simple particulate filter elements, for filtering larger solid particles that are present in the incoming water, to filter elements that are intended to remove certain chemicals that are present in the incoming water, such as chlorine and organic contaminants. More recently, point-of-entry water treatment units have become available that incorporate ultraviolet lamps for disinfecting the water by exposing it to ultraviolet light in order to inactivate pathogens and other microorganisms that may be present in the incoming water.

Typically, separate filter units are available for the removal of the several forms of undesirable contaminants that may be present in water for household use. It is therefore desirable to provide in a unitary vessel a treatment system for removing particulates and chemicals, and for disinfection of microorganisms. Desirably, such a vessel is of a relatively compact size and is one that is adaptable for retrofitting into existing home water distribution systems.

### SUMMARY OF THE INVENTION

Briefly stated, in accordance with one aspect of the present invention, a water treatment system is provided that includes a treatment vessel having an inlet for receiving incoming water from a water source, and having an outlet for discharging treated water. A first filter element carried within the treatment vessel is provided for removing particulates present in the incoming water. A second filter element carried within the treatment vessel is provided for removing chemical compounds present in the incoming water. And an ultraviolet light treatment element carried within the treatment vessel is provided for disinfection of microorganisms present in the incoming water.

### BRIEF DESCRIPTION OF THE DRAWINGS

FIG. 1 is a diagrammatic elevational view of one form of an in-home water treatment system in accordance with the present invention;

FIG. 2 is a longitudinal cross-sectional view of a water treatment vessel forming part of the system shown in FIG. 1;

FIG. 3 is an enlarged, fragmentary cross-sectional view adjacent the base region of the water treatment vessel shown in FIG. 2;

FIG. 4 is an enlarged, fragmentary cross-sectional view adjacent the top region of the water treatment vessel shown in FIG. 2;

FIG. 5 is a cross-sectional view taken along the line 5-5 of FIG. 2;

FIG. 6 is a cross-sectional view taken along the line 6-6 of FIG. 2;

FIG. 7 is a side view of a two-stage filter assembly, partially broken away to show the internal structure;

FIG. 8 is a side view of a particulate filter pad of tubular form;

FIG. 9 is an end view of the filter pad of FIG. 8;

FIG. 10 is a side view, partially broken away, of a carbon cartridge filter of tubular form;

FIG. 11 is an end view of the carbon cartridge filter shown in FIG. 9; and

FIG. 12 is a top view of the water treatment vessel shown in FIG. 1.

### DESCRIPTION OF THE PREFERRED EMBODIMENTS

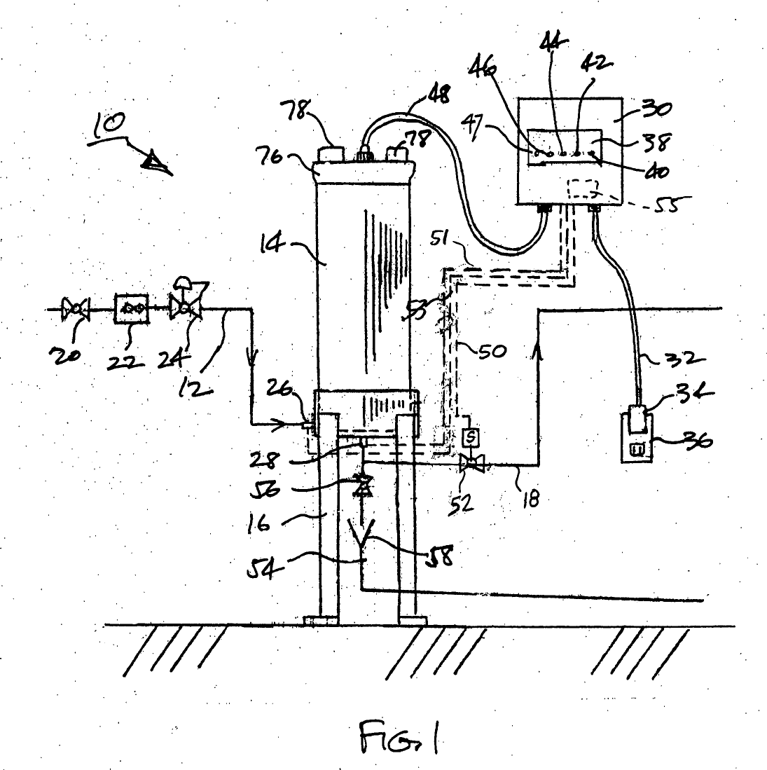

Referring now to the drawings, and particularly to FIG. 1 thereof, there is shown a schematic elevational view of a water treatment system 10 that can be utilized in a home, at a school, and in other places. The system shown and described herein is particularly suitable in applications in which the maximum water flow rate is of the order of about 12 gallons per minute, or less.

System 10 includes an incoming water supply conduit 12 that is connected with a treatment vessel 14 that can be carried on a stand 16. If desired, treatment vessel 14 can also be wall-mounted, or it can be supported in other ways. Incoming water, such as is commonly supplied by a municipal water source, or is derived from a groundwater source such as a well or a spring, enters vessel 14 through supply conduit 12, where it undergoes three treatment stages. The treated water exits from vessel 14 though outlet conduit 18 to be conveyed to the household water distribution system (not shown).

Supply conduit 12 includes a supply shutoff valve 20, and it can also include a flow meter 22 for measuring the rate and amount of water flow. A pressure regulating valve 24 can be provided for controlling the pressure of the water before it enters treatment vessel 14 and the household water system. Flow meter 22 and pressure regulating valve 24 can be positioned downstream of shutoff valve 20 as shown, or one or both of them can be positioned upstream of shutoff valve 20, if desired.

From supply conduit 12 the incoming water enters treatment vessel 14 at vessel inlet 26. The incoming water flows within vessel 12 and through three successive treatment stages, after which treated water exits from vessel 12 at vessel outlet 28 to enter outlet conduit 18 and to be distributed to the various water usage points within the home.

Operation of treatment system 10 is controlled by an electrical control housing 30 that is connected with a standard 120-volt household outlet through a power cord 32. A leakage current interrupter 34 can be provided in power cord 32, or connected with an electrical outlet 36, as a safety measure. Control housing 30 includes a display panel 38 with several suitable switches and indicators. As shown in FIG. 1, display panel 38 includes a system on-off switch 40, a unit-on indicator 42, which can be a visual indicator, such as a light-emitting diode, or the like, and a treatment element replacement indicator 44, which can also be a visual indicator, such as light-emitting diode, or the like, to show the need for treatment element replacement. Additionally, control housing 30 can include a clock (not shown) to monitor the treatment system operating time, and a clock reset button 46 to reset the clock after the replacement of a water treatment element within treatment vessel 14.

Control housing 30 also includes a power cable 48 to deliver electrical power to treatment vessel 14, an electrical conduit 50 that is connected with a solenoid-operated valve 52 in outlet conduit 18, and pressure conduits 51, 53 that are connected to a differential pressure switch 55 within control housing 30. Valve 52 can be arranged, through suitable control circuitry (not shown), to stop the flow of water from treatment vessel 14 to the household water system in the event of a treatment system malfunction, or in the event of a failure to timely replace a water treatment element that is contained within treatment vessel 14. Differential pressure switch 55 is utilized to activate visual indicator 47 when a set point differential pressure across the treatment system is exceeded, which indicates that first filter element 84 is clogged with accumulated particulate matter, such as sediment, and requires cleaning or replacement.

In addition to its connection with the household water distribution system, vessel outlet 28 is adapted to communicate with a drain conduit 54 in which a manually operable drain valve 56 is provided to allow or to prevent the flow of water from treatment vessel 14 into drain conduit 54, such as through a drain receptacle 58.

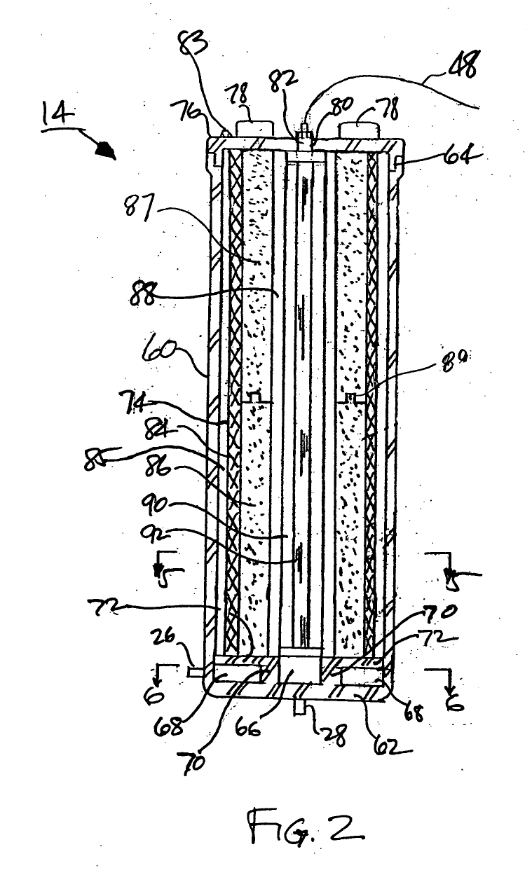

Treatment vessel 14 and its interior elements and structure are shown in longitudinal cross-sectional form in FIG. 2. Vessel 14 is a generally tubular housing and can be of cylindrical form, as shown in the drawings. Advantageously, from cost and simplicity of manufacture standpoints, treatment vessel 14 can be an injection-molded structure that can be formed from polypropylene, ABS, polycarbonate, or other polymeric materials suitable for use in pressurized potable water systems. Treatment vessel 14 is defined by an annular vessel sidewall 60, by a disk-like, closed vessel bottom wall 62, and by a vessel top opening 64. Vessel bottom wall 62 includes vessel outlet 28, which is located at a generally axial position, relative to vessel sidewall 60, and which communicates with an outlet plenum chamber 66 that serves as a treated water collection well. Vessel inlet 26 is spaced above vessel bottom wall 62 and communicates with an annular inlet plenum chamber 68. Outlet plenum chamber 66 is separated from inlet plenum chamber 68 by an axially-extending annular separator wall 70 that extends upwardly from vessel bottom wall 62 to a radially-extending divider wall 72 that separates inlet plenum chamber 68 from vessel inner chamber 74.

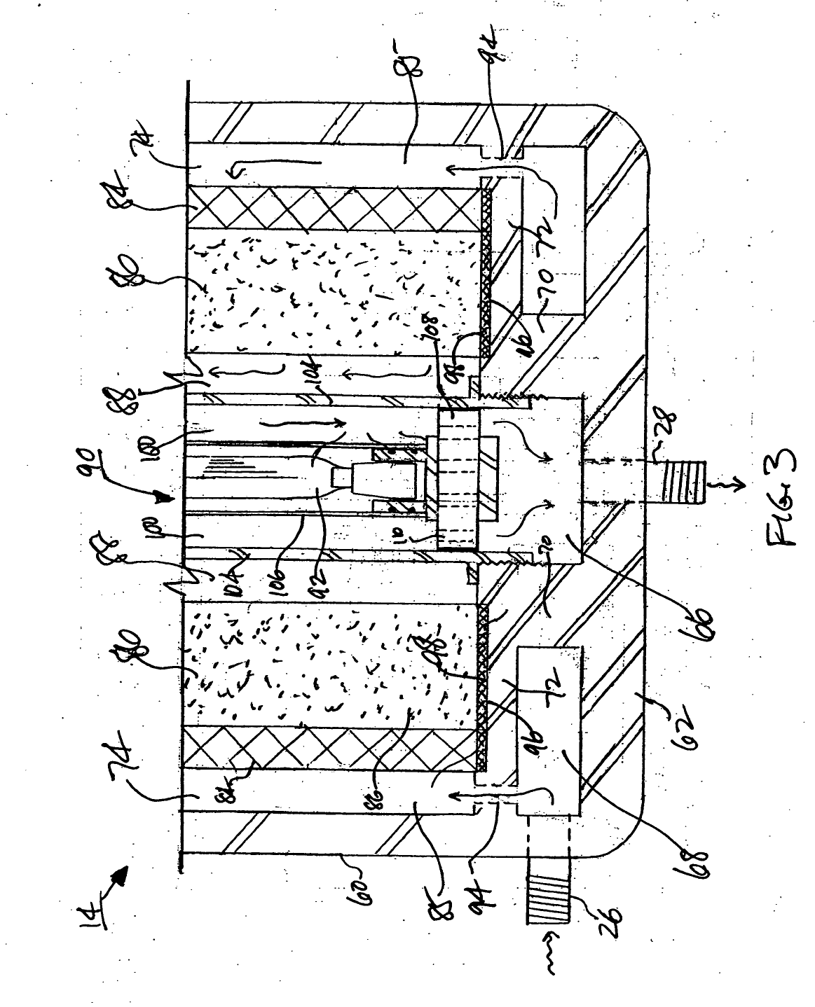

Vessel top opening 64 is closed by a top end cap 76 that can be removably connected with the upper end of vessel sidewall 60, such as by a threaded connection, as shown in FIG. 4. Top end cap 76 includes several radially-extending, circumferentially-spaced projections that serve as twist-off handles, to allow convenient attachment and removal of top end cap 76 from vessel 14, as necessary. Top end cap 76 also includes a centrally-positioned opening 80 to receive a power cable connector 82, and a pressure relief valve 83.

Positioned axially within vessel inner chamber 74 and spaced inwardly of the interior surface of vessel sidewall 60 is a first filter element 84. Element 84 is in the form of a relatively thin wall, semi-rigid, annular filter pad for filtering sediment and other particulate matter contained in the incoming water to be treated. The radial spacing between vessel sidewall 60 and the outer surface of first filter element 84 defines an outer annular flow channel 85 and can be of the order of from about ¼ to about ½ inch, to allow axial flow of incoming water along the outer periphery of first filter element 84, and to thereby expose incoming water to a relatively large surface area through which the incoming water can flow radially inwardly toward the center of treatment vessel 14. The radial thickness of first filter element can be of the order of from about 1/4 inch to about 3/4 inch, depending upon the porosity of the material that is utilized to form that filter element and the desired cleaning frequency of the filter element. In that regard, first filter element is capable of filtering from the incoming water particulate matter having a particle size of about 5 microns or larger.

Second filter elements 86, 87 are positioned axially within first filter element 84 and can also be of annular form. Second filter elements 86, 87 are rigid, porous carbon block filters for removing from the incoming water that passes therethrough such chemical contaminants as chlorine, chlorinated by-products, and other inorganic and organic compounds that can adversely affect the taste and odor of the water that is to be treated. The radial thickness of each of second filter elements 86, 87 is greater than that of first filter element 84 to provide adequate contact time for adsorption of organic contaminants from the water, typically from about ¾/inch to about 1 inch.

For larger treatment vessels, such as is shown in FIG. 2, two axially-aligned second filter elements can be provided to facilitate removal and replacement of the second filter elements when necessary during use of the apparatus. A key-notch-type orientation arrangement 89 can be provided at the lower end of uppermost filter element 87 and at the top end of lowermost filter element 86 to ensure proper alignment of the second filter elements when they are installed within treatment vessel 14. Additionally, a tubular-shaped open-lattice plastic connector can be inserted within the interior annular space of both second filter elements to join the two elements together using a compression seal to facilitate the insertion into and the removal from treatment vessel 14 of the joined filter elements.

Positioned axially within second filter elements 86, 87, and spaced radially inwardly thereof to define an inner annular flow channel 88 therebetween, is a third water treatment element 90. Treatment element 90 is in the form of an ultraviolet light treatment reactor for disinfection treatment of the water by exposure of the water to ultraviolet light in order to inactivate microorganisms that may be present within the incoming water. Treatment element 90 includes an ultraviolet lamp 92 that is axially positioned within vessel 14 and is spaced inwardly from and concentric with each of first filter element 84 and second filter elements 86, 87. The ultraviolet light provided by treatment element 90 serves to inactivate pathogenic microorganisms, such as Cryposporidium, Giardia lambila, bacteria, viruses, and the like, and it avoids the need to use hazardous disinfection chemicals that can produce undesired residual chemical compounds or possibly hazardous byproducts. Treatment element 90 is adapted to provide ultraviolet radiation at wavelengths of about 254 nanometers and can be a standard, low-pressure ultraviolet lamp, for which effective light-based disinfection of waterborne microorganisms can take place. The space between the outer surface of treatment element 90 and the inner surfaces of second filter elements 86, 87 defines inner annular flow channel 88, which serves to allow water that has passed through first filter element 84 and second filter elements 86, 87, and that has been filtered to remove particulates and undesirable chemical compounds, to flow coaxially along the outer surface of treatment element 90 for the final treatment step, which involves inactivation of microorganisms in the water.

The structure of vessel 14 and the arrangement of the several treatment elements positioned therewithin are shown in greater detail in FIGS. 3 and 4, which are enlarged, fragmentary, cross-sectional views of the several treatment elements, as well as the vessel structure at the bottom and at the top regions, respectively, of vessel 14. Referring first to FIG. 3, the base portion of vessel 14 includes annular inlet plenum chamber 68 that is bounded by vessel bottom wall 62, by radially-extending divider wall 72 that is spaced axially from bottom wall 62, by axially-extending separator wall 70 that extends between bottom wall 62 and divider wall 72, and by vessel sidewall 60. Inlet plenum chamber 68 communicates with inlet connection 26 to receive the water to be treated, and it serves to distribute the incoming water circumferentially within the interior of vessel 14. In that regard, a plurality of substantially axially-extending, circumferentially-spaced openings 94 are provided in divider wall 72 adjacent vessel sidewall 60 to provide communication between inlet plenum chamber 68 and outer annular flow channel 85. The number, spacing, and size of openings 94 are selected to provide the desired flow rate and flow distribution into the treatment section of vessel 14 of the incoming water that is to be treated.

Divider wall 72 within vessel 14 includes an annular recess 96 in its upper surface to receive a flexible, annular sealing ring 98 against which rest the lower end surfaces of each of first filter element 84 and second filter elements 86, 87. Sealing ring 98 can be made from neoprene rubber, or the like, and it serves to prevent water flow around the lower ends of the first and second filter elements so that the water is confined to flow through the respective elements rather than bypassing them.

Separator wall 70 within vessel 14 is so sized and positioned as to provide a desired volume for outlet plenum chamber 66, which communicates both with outlet connection 28 and with an inner annular flow channel 100 outside third treatment element 90. Separator wall 70 can be formed with an internal thread 102, which is adapted to threadedly receive an end of a tubular housing 104 of cylindrical form that forms part of third treatment element 90. Housing 104 can be made from stainless steel, or the like, and serves to define the interior surface of intermediate annular flow channel 88 and the outer surface of inner annular flow channel 100.

Axially positioned within housing 104 is tubular ultraviolet lamp 92 that is surrounded by a protective tubular quartz glass sleeve 106, which is capable of transmitting ultraviolet light with minimal absorbance. Sleeve 106 has an outer diameter that is smaller than the inner diameter of housing 104 to define therebetween inner annular flow channel 100, through which the water to be treated flows in an axial direction toward outlet plenum 66. The lowermost end of sleeve 106 carries an annular centralizer ring 108, which extends between housing 104 and sleeve 106 to position lamp 92 centrally within housing 104. Centralizer ring 108 need not be fixed to housing 104, but can be so sized as to provide a snug fit therewith, to allow centralizer ring 108 to slide along the inner surface of housing 104 to facilitate removal of treatment element 90. Centralizer ring 108 includes a plurality of axially-extending openings 110 to allow water to flow from within inner annular flow channel 100 into outlet plenum 66. The number, spacing, and size of openings 110 are selected to control the flow rate and the flow distribution of the water within inner annular flow channel 100 into outlet plenum 66, to achieve a desired exposure time of the water to ultraviolet light.

FIG. 4 shows in cross section the upper interior portion of vessel 14. The upper ends of each of first filter element 84 and second filter elements 86, 87 are retained against a flat, annular sealing ring 114 similar to sealing ring 98. Sealing ring 114, which can be made from neoprene rubber, or the like, is received in a correspondingly-shaped annular recess 116 formed in the lower surface of top end cap 76. Sealing ring 114 serves to prevent water flow around the upper ends of first filter element 84 and second filter elements 86, 87, so that the water to be treated is confined to flow from outer flow channel 85 into and through each of the first and second filter elements to intermediate flow channel 88, rather than bypassing the filter elements. Positioned radially inwardly of ring 114, and coaxial therewith, is an inner sealing ring 118 that is received within annular recess 120 formed in top end cap 76. Inner sealing ring 118 is adapted to provide a seal between annular top end connector 122, which includes an annular body member 124 that is threadedly received at the upper end of tubular housing 104. Sealing ring 118 serves to prevent water flow between the upper end of tubular housing 104, top end connector 122, and top end cap 76. Connector 122 includes a downwardly-extending, coaxial sleeve 126 that carries on its outer surface a pair of O-rings 128 to sealingly engage with the upper inner surface of tubular sleeve 107, and an upwardly-extending, coaxial sleeve 130 that carries on its inner surface a pair of O-rings 132 to sealingly engage with ultraviolet lamp cable connector 82 that extends from ultraviolet lamp 92. Cable connector 82 is retained by an end fastener 134 that threadedly engages with cable connector 82 and top end connector 122 and that abuts the upper outer surface of top end cap 76. The ultraviolet lamp assembly, which includes cable connector 82 and ultraviolet lamp 92, can be removed from treatment element 90 by disengaging end fasteners 134 and lifting out the lamp assembly through the opening in top end connector 122.

Top end cap 76 is threadedly received at the uppermost end of vessel 14. An O-ring 136 provides a seal between vessel sidewall 60 and end cap 76 to prevent water leakage therebetween. A positive, water-tight seal is also provided between top end cap 76 and each of first filter element 84 and second filter element 86, 87 by sealing ring 114 and between top end cap 76 and top end connector 122 by inner sealing ring 118. Each of sealing rings 114 and 118 is at least partially compressed when top end cap 76 is tightened against the upper end of vessel sidewall 60. Top end cap 76 also includes a central opening to coaxially receive annular sleeve 130 of top end connector 122. The disclosed structural arrangement allows top end cap to be threadedly engaged with or disengaged from vessel sidewall 60 while top end connector 122 remains stationary and secured to tubular housing 104 of third treatment element 90.

Visible in FIG. 4 are axial projections 78 that are provided to facilitate attachment to and removal from vessel 14 of end cap 76 for access to the filters and ultraviolet lamp for servicing purposes. Additionally, pressure relief valve 83 is provided in top end cap 76 to allow bleedoff of air that is trapped within vessel 14 after the application of top end cap 76, and also to allow depressurization of the interior of vessel 14 after incoming water flow has been shut off, at a time when access to the treatment elements contained within vessel 14 is desired.

FIG. 4 also shows positioned at an end of tubular housing 104 a plurality of axially-elongated, circumferentially-spaced, openings in the form of slot-like passageways 138 to allow flow of filtered water from intermediate annular flow channel 88 into inner annular flow channel 100 to allow exposure of the filtered water to ultraviolet light for the third, disinfection stage of treatment. Passageways 138 are positioned adjacent the uppermost end of tubular housing 104 to cause the filtered water to enter inner annular flow channel 100 at its uppermost end and to flow axially substantially completely along quartz sleeve 106 for an extended exposure time of the water to ultraviolet light that emanates from lamp 92 for improved disinfection.

FIG. 5 is a cross-sectional view through vessel 14 adjacent to the lower end thereof to show the internal arrangement of the first and second filter elements 84, 86 and the third, disinfection element 90 including ultraviolet lamp 92. Also shown are outer annular flow channel 74, into which incoming water to be treated passes from inlet connection 26, along with openings 94 in divider wall 72; intermediate annular flow channel 88 between second filter elements 86, 87 and tubular housing 104; and inner annular flow channel 100, along with openings 110 that lead into outlet plenum 66.

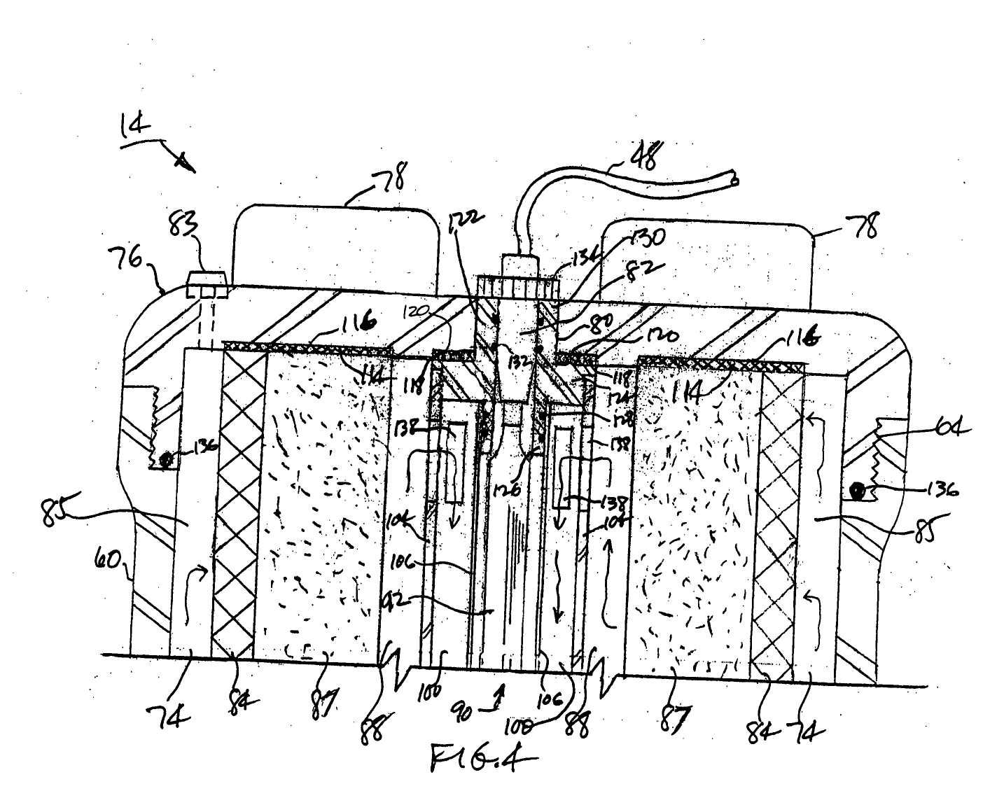

FIG. 6 is a cross-sectional view through vessel 14 between bottom wall 62 and divider wall 72. As shown, inlet plenum 68 is of annular form and is separated from cylindrically-shaped outlet plenum 66 by axially-extending separator wall 70.

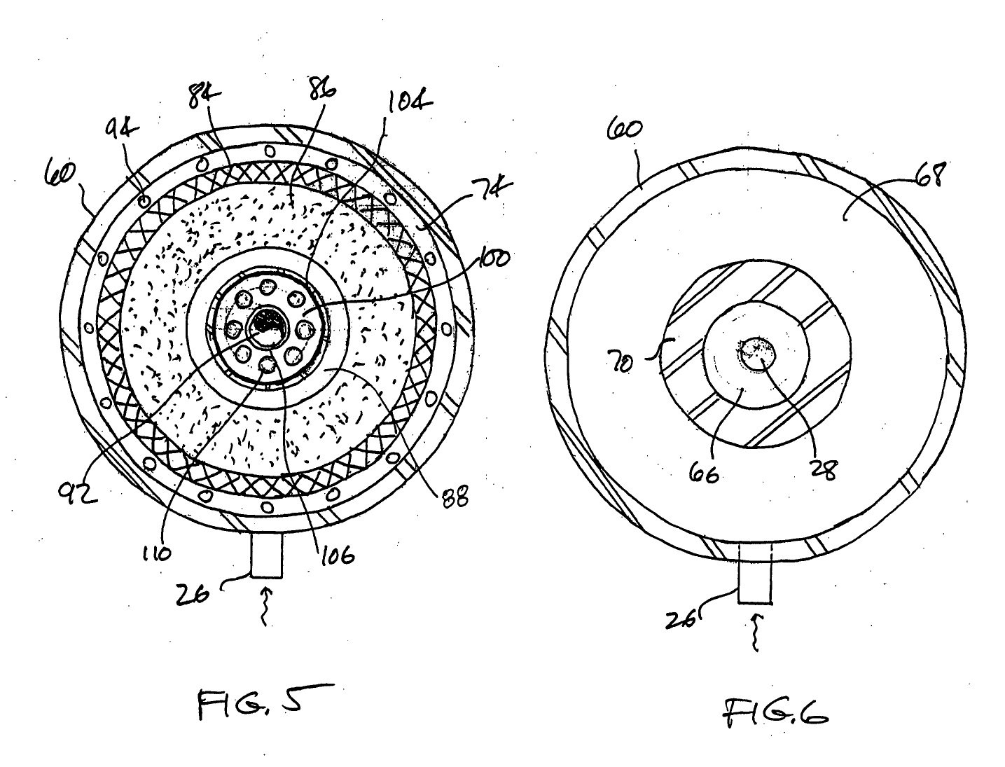

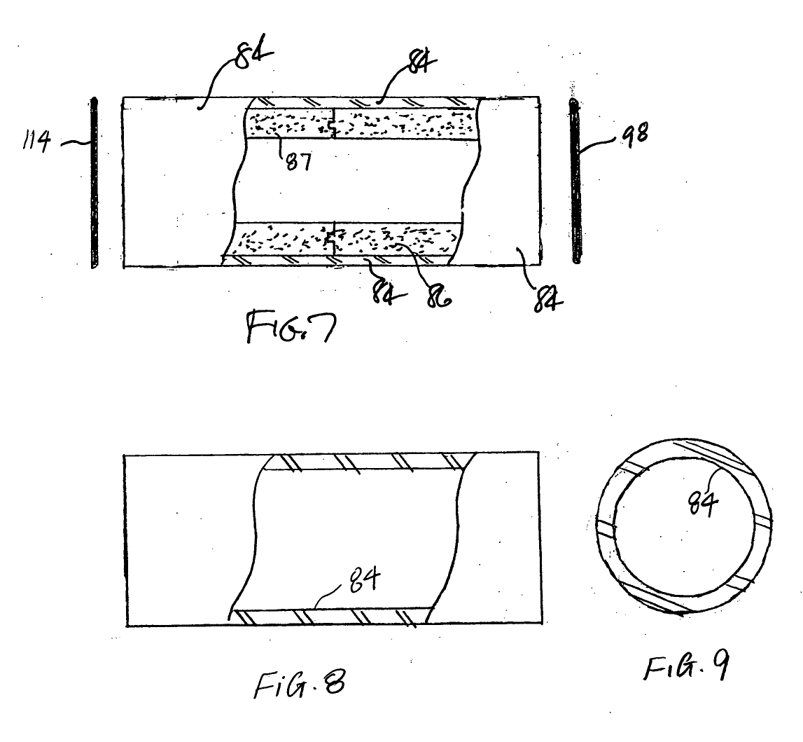

FIG. 7 is a side view, partially broken away, showing first filter element 84 and second filter elements 86, 87 in assembled form to provide a unitary, tubular filter structure. Inner, second filter elements 86, 87 are surrounded by first filter element 84, which is a semi-rigid, cylindrical filter pad formed from spun fibers. Tubular first filter element 84 is shown in a side view in FIG. 8 and in an end view in FIG. 9.

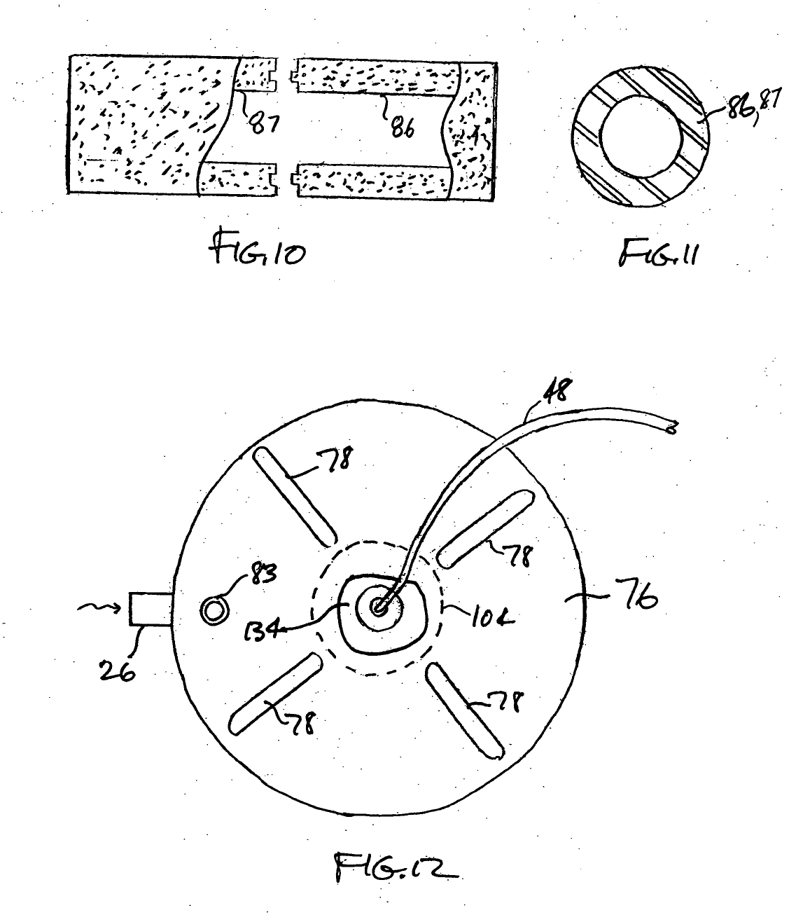

Second filter elements 86, 87 are shown in FIG. 10 in a side view, partially broken away, and in an end view in FIG. 11. As is apparent from FIGS. 8 through 11, first filter element 84 and second filter elements 86, 87 each have a tubular structure. First filter element 84 is placed around and in contact with the outer surfaces of each of second filter elements 86, 87, providing a snug fit therebetween and assuring proper coaxial alignment of each of the second filter elements.

FIG. 12 shows a top view of vessel 14. In addition to top end cap 76, also shown in FIG. 12 are the four axial projections 78 that extend upwardly from top end cap 76 and that define twist-off handles to allow removal of top end cap 76 from vessel 14 for servicing of the interior components that are housed within vessel 14. Also shown is power cable 48 for supplying electrical power to the ultraviolet lamp.

In the operation of the above-described disinfection system, only periodic monitoring of control panel 30 is needed to determine whether the filter elements and ultraviolet lamp need replacement. Generally, for a typical home system that is sized for a maximum flow rate of about 12 gallons per minute and an average flow rate of about 4 gallons per minute, only annual carbon filter and lamp replacement is anticipated. The outer, particulate filter may require more frequent cleaning or replacement, depending upon the quality of the water being treated and the volume of water usage. The standard, low-pressure ultraviolet lamp generally operates at about 60° C. and therefore will not overheat. It can remain on continuously, even if no flow takes place over a number of days or weeks.

Although particular embodiments of the present invention have been illustrated and described, it will be apparent to those skilled in the art that various changes and modifications can be made without departing from the spirit of the present invention. Accordingly, it is intended to encompass within the appended claims all such changes and modifications that fall within the scope of the present invention.

1. A water treatment system comprising:
a) a treatment vessel having an inlet for receiving incoming water from a water source, and having an outlet for discharging treated water;
b) a first filter element carried within the treatment vessel for removing particulates present in the incoming water;
c) a second filter element carried within the treatment vessel for removing chemical compounds present in the incoming water; and
d) an ultraviolet light treatment element carried within the treatment vessel for inactivating microorganisms present in the incoming water.

2. A water treatment system in accordance with claim 1, wherein the filter elements and the treatment element are substantially tubular elements that are concentrically disposed within the treatment vessel.

3. A water treatment system in accordance with claim 1, wherein the filter elements and the treatment element are positioned within the treatment vessel to treat the water sequentially to first remove particulates, and then remove chemical compounds, and finally inactivate microorganisms as the water flows through the treatment vessel.

4. A water treatment system in accordance with claim 3, wherein the first filter element is positioned to receive incoming water from the treatment vessel inlet and the second filter element is positioned downstream of the first treatment element.

5. A water treatment system in accordance with claim 4, wherein the ultraviolet light treatment element is positioned downstream of the second filter element.

6. A water treatment system in accordance with claim 1, wherein the first filter element is a substantially tubular element.

7. A water treatment system in accordance with claim 1, wherein the second filter element is a substantially tubular element.

8. A water treatment system in accordance with claim 7, wherein the second filter element is positioned concentrically within the first filter element.

9. A water treatment system in accordance with claim 7, wherein the second filter element includes a plurality of coaxially-aligned tubular elements.

10. A water treatment system in accordance with claim 8, wherein the ultraviolet light treatment element is a substantially tubular element and is positioned concentrically within the second filter element.

11. A water treatment system in accordance with claim 1, wherein the first filter element is formed from a porous, spun fiber pad having a tubular configuration.

12. A water treatment system in accordance with claim 11, wherein the first filter element has flow openings having a size to capture particulates having a particle size larger than about 5 microns.

13. A water treatment system in accordance with claim 1, wherein the second filter element is formed from a porous, activated carbon material.

14. A water treatment system in accordance with claim 13, wherein the second filter element has flow openings to remove particulates having particle sizes of from about 5 microns to about 10 microns.

15. A water treatment system in accordance with claim 13, wherein the second filter element is a porous, substantially rigid, activated carbon block.

16. A water treatment system in accordance with claim 1 wherein the vessel is a tubular structure having an inlet plenum that communicates with the vessel inlet to receive incoming water, and the inlet plenum includes a plurality of distribution apertures to distribute the incoming water substantially uniformly to the first filter element.

17. A water treatment system in accordance with claim 16, wherein the inlet plenum is an annular container.

18. A water treatment system in accordance with claim 1, wherein the vessel includes an outlet plenum that communicates with the vessel outlet to collect treated water.

19. A water treatment system in accordance with claim 17, wherein the inlet plenum is concentric with and surrounds the outlet plenum.

20. A water treatment system in accordance with claim 1, wherein the ultraviolet light treatment element includes a low-pressure ultraviolet lamp.

21. A water treatment system in accordance with claim 20, wherein the ultraviolet lamp is positioned within a tubular quartz sleeve.

22. A water treatment system in accordance with claim 1, including sealing rings positioned at longitudinal ends of the first and second filter elements to substantially prevent water flow from bypassing the first and second filter elements.

23. A water treatment system in accordance with claim 21, wherein the quartz sleeve is positioned radially inwardly of the second filter element to define an annular water flow passageway therebetween.

24. A water treatment system in accordance with claim 23, wherein the annular water flow passageway communicates with the outlet plenum through a plurality of circumferentially-distributed openings.

25. A water treatment system in accordance with claim 1, including a differential pressure switch for actuating a visual alarm when a pressure drop within the system exceeds a predetermined value.

26. A water treatment system in accordance with claim 1, wherein the treatment vessel includes a removable end cap that is sealingly engaged with internally-positioned treatment elements to prevent bypass flow therebetween.

27. A water treatment system in accordance with claim 26, wherein the end cap includes an opening to facilitate removal of components of the ultraviolet light treatment element.

28. A water treatment system in accordance with claim 1, including means for maintaining the ultraviolet light treatment components in a substantially axial position within the vessel when the end cap is removed.

29. A method for treating water for household use, said method comprising the steps of;
a) passing untreated water through a particulate filter to remove particulate matter from the water in a first treatment stage;
b) passing water that has passed through the particulate filter through a chemical-compound-removing filter element for removing chemical compounds from the water in a second treatment stage; and
c) passing treated water from the chemical-compound-removing filter element through a purification section in a third treatment stage to inactivate microorganisms present in the water.

30. A method in accordance with claim 29, wherein the treatment stages are sequentially arranged within a unitary treatment vessel.

31. A method in accordance with claim 30 wherein the treatment sequence is first, particulate removal, second, chemical compound removal, and third, microorganism inactivation.

32. A water treatment system comprising:
a) a treatment vessel having an inlet for receiving incoming water from a water source, and having an outlet for discharging treated water;
b) at least one filter element carried within the treatment vessel for removing at least one of particulates and chemical compounds from the incoming water; and
c) an ultraviolet light treatment element carried within the treatment vessel for inactivating microorganisms present in the incoming water.
